(19) United States
(12) Patent Application Publication
(10) Pub. No.: US 2025/0229295 A1
(43) Pub. Date: Jul. 17, 2025

(54) SAND PRODUCTION SYSTEMS, METHODS, AND APPARATUS

(71) Applicant: Superior Industries, Inc., Morris, MN (US)

(72) Inventors: John Rodriguez, Morris, MN (US); Michael Dunne, Londonderry (GB)

(21) Appl. No.: 18/854,829

(22) PCT Filed: Apr. 6, 2023
(86) PCT No.: PCT/US2023/065470

§ 371 Date: Oct. 7, 2024

Related U.S. Application Data
(60) Provisional application No. 63/362,582, filed on Apr. 6, 2022.

(51) Int. Cl. B07B 1/40; B03B 5/00

(52) U.S. Cl. CPC B07B 1/40; B03B 5/00; B07B 2230/01

(57) ABSTRACT

Systems, methods and apparatus are provided for producing sand. Some embodiments include an agitator and dewatering screen. Some embodiments include a blending gate assembly configured to direct selected amounts of material to the agitator and to a crusher.

BACKGROUND

Sand is produced according to various industrial specifications by using processes and equipment to size and/or wash aggregate material. Some sand production systems and methods include rock crushers and dewatering screens.

### BRIEF DESCRIPTION OF THE DRAWINGS

FIG. 1 schematically illustrates an embodiment of a system for carrying out an embodiment of an aggregate processing method.

FIG. 2 is a plan view of an embodiment of an aggregate processing plant.

FIG. 3 schematically illustrates another embodiment of a system for carrying out an embodiment of an aggregate processing method.

FIG. 4 is a sectional view of an embodiment of a washing apparatus.

### DESCRIPTION

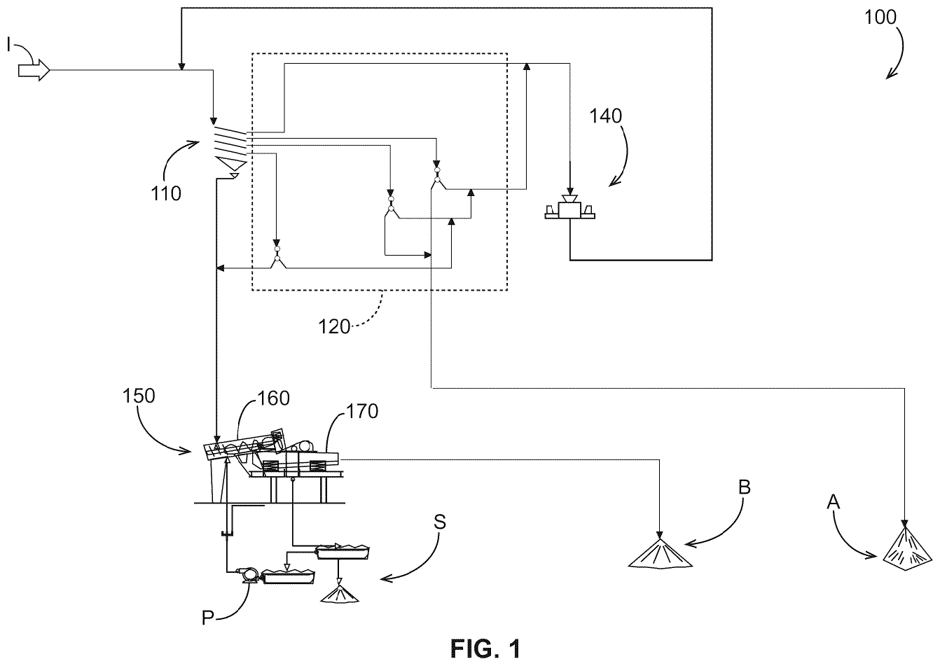

Referring to the drawings, wherein like reference numerals designate identical or corresponding parts throughout the several views, FIG. 1 schematically illustrates an embodiment of a system 100 for carrying out an embodiment of an aggregate processing method (e.g., to produce sand). Aggregate material introduced at inlet I is deposited on the upper deck of a vibratory screen 110 (e.g., three-deck screen, four-deck screen, incline screen, horizontal screen, multi-slope screen, etc.). The screen 110 classifies material to produce material of a plurality of classifications, for example using a plurality of decks, each deck having classifying media. In one example, the screen 110 can include a first classification of material passing over the uppermost deck, a second classification of material passing through the uppermost deck but passing over the second deck, a third classification of material passing through the second deck but passing through the third deck, a fourth classification of material passing through the third deck but passing over the fourth deck, a fifth classification of material passing through all decks of the screen, etc. In some embodiments, a blending gate assembly 120 blends the of materials passing over each deck of the screen 110 such that desired amount or fraction of one or more classifications of material is produced and passed to one or more selected destinations for further processing. The blending gate assembly 120 optionally comprises a plurality of blending gates having adjustable dividers for selecting an amount or fraction or material one of two or more directions. A selected fraction of material passing over one or more screen decks (e.g., the second and third decks) is optionally transferred out of the system 100, e.g., to a product stockpile A. The material in stockpile A optionally comprises screened chip aggregate such as—½″ chip aggregate. Screen 110 is in material communication with a crusher 140 such that a selected fraction of material passing over one or more screen decks (e.g., over the uppermost deck) is optionally transferred to and enters the inlet of the crusher 140 (e.g., an impact crusher such as a vertical shaft impact crusher for crushing material such as rocks to produce a crushed material). Material processed by crusher 140 is then optionally recirculated back to the screen 110 (e.g., by one or more conveyors or other apparatus and/or structure).

Screen 110 is in material communication with a washing apparatus 150. Material passing through all decks of the screen 110, and optionally a selected fraction of material passing over one or more screen decks (e.g., over the bottom deck such as third deck of a three-deck screen or the fourth deck of a four-deck screen) is optionally transferred to the inlet of the washing apparatus 150. The washing apparatus 150 optionally comprises an agitator 160 having a water inlet configured to agitate material that enters the agitator 160 to produce a wet agitated slurry. The washing apparatus 150 optionally comprises a dewatering screen 170 optionally disposed to receive wet slurry from the agitator 160 and remove water from the wet slurry in order to produce a dry product (e.g., sand). It should be appreciated that in various embodiments, the agitator 160 is supported on a common frame with the dewatering screen 170, or may be supported separately from the dewatering screen 170. The dewatering screen optionally includes one or more spray elements disposed to direct water onto material. A pump P optionally provides water (e.g., from a pond or other water source S) to the agitator 160 and/or to the spray elements of dewatering screen 170. Material passing over the dewatering screen 170 is optionally transferred out of the system (e.g., to a stockpile B). The material in stockpile B optionally comprises sand such as concrete sand (e.g., C-33 specification sand). Material passing through dewatering screen is optionally further dewatered (e.g., in one or more sand bags, dewatering boxes, geotextile tubes, sludge lagoons, etc.) in order to recover water therefrom, which water is optionally returned to water source S.

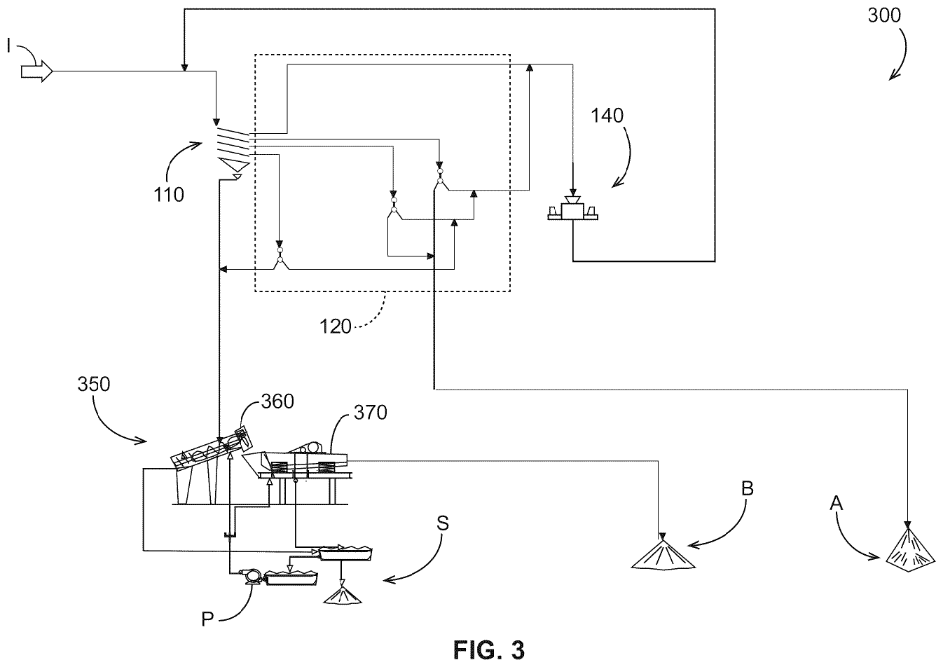

Referring to FIG. 3, an alternative embodiment of a system 300 is illustrated. System 300 is generally equivalent to the system 100 except that washing apparatus 150 is replaced with a washing apparatus 350 comprising a material propulsion device 360 (e.g., a scrubber, coarse material washer, fine material washer, blade mill, etc.) positioned to propel material onto a dewatering screen 370. It should be appreciated that material propulsion device 360 may be supported on a common frame with dewatering screen 370 or in other embodiments may be supported separately from the dewatering screen 370. In some embodiments the material propulsion device 360 includes an overflow weir or other structure permitting water to overflow a tank of the propulsion device separately from a forward exit of the tank.

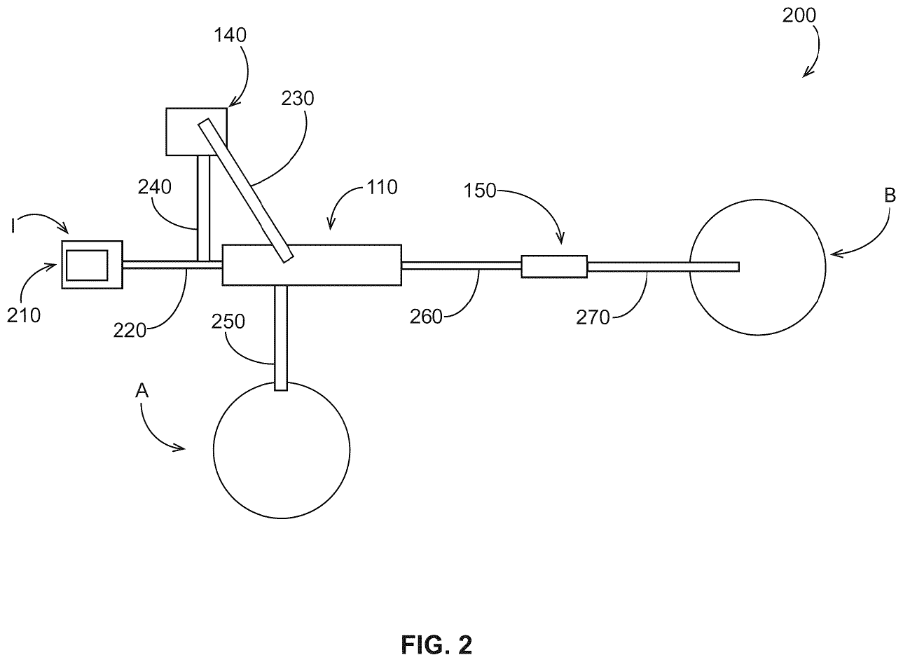

Referring to FIG. 2, an embodiment of aggregate processing plant 200 comprising the equipment of system 100 is illustrated. At inlet I the plant 200 optionally includes a hopper 210 or other structure for receiving aggregate material (e.g., from a loader, conveyor or other equipment). A conveyor 220 optionally conveys aggregate material from inlet I to the screen 110. A conveyor 230 optionally conveys the selected fraction of material passing over one or more screen decks (e.g., over the uppermost deck) to the inlet of crusher 140. A conveyor 240 optionally conveys at least a fraction of the output of crusher 140 onto the conveyor 220. A conveyor 250 optionally conveys a selected fraction of material passing over one or more screen decks (e.g., the second and third decks) to stockpile A. A conveyor 260 optionally conveys a selected fraction of material passing over one or more screen decks (e.g., over the third deck) to washing apparatus 150. A conveyor 270 optionally conveys a material passing over the dewatering screen 170 of washing apparatus to stockpile B. The conveyors described in this paragraph optionally comprise stationary conveyors such as jump conveyors and are optionally configured and/or disposed to elevate material being conveyed thereon from a first height to a second height.

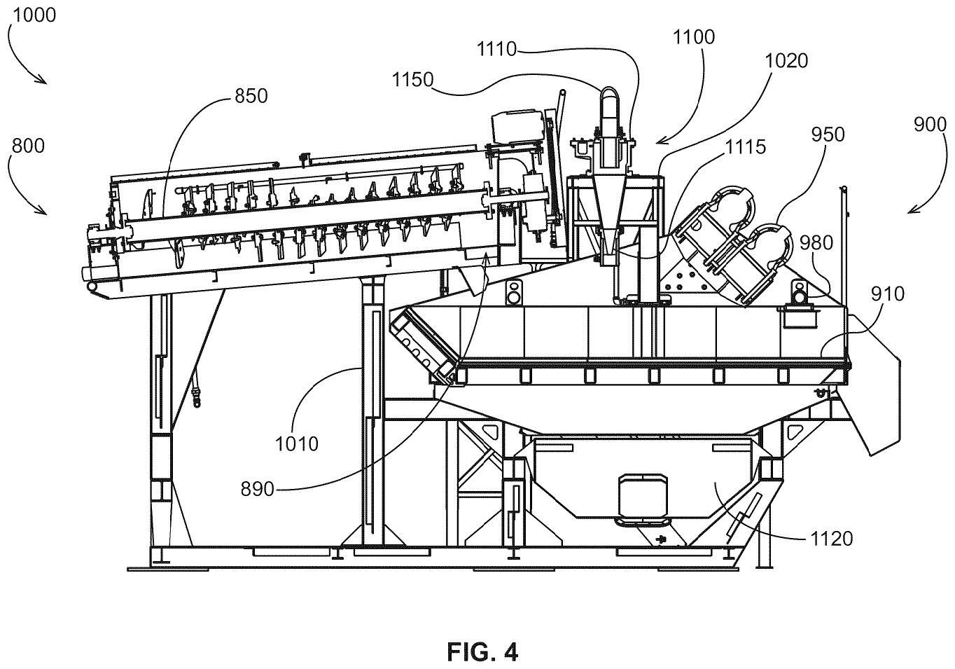

Referring to FIG. 4, another embodiment of a washing apparatus 1000 is illustrated. The washing apparatus 1000 optionally comprises a slurrying mechanism 800 and a dewatering screen 900. Slurrying mechanism 800 optionally comprises a propulsion assembly 850 configured to propel material to an outlet 890. In some embodiments, the washing apparatus 1000 includes a recirculation circuit 1100 comprising a hydrocyclone 1110. The hydrocyclone 1110 is optionally supported above the dewatering screen 900 and optionally is not supported by the dewatering screen 900, e.g., the hydrocyclone 1110 is optionally supported on a frame 1020 such that the hydrocyclone is at least partially isolated from vibration of the dewatering screen. One or more frames 1010 support the slurrying mechanism 800 and dewatering screen 900; the slurrying mechanism and dewatering screen 900 are optionally independent and/or mobile next to one another, or in some embodiments supported on a common frame 1010. The frame 1020 is optionally supported on frame 1010 or in some embodiments is supported independently from frame 1010.

In operation of the washing apparatus 1000, feed material (e.g., aggregate material and water) is fed into the slurrying mechanism 800. The slurrying mechanism forms a slurry (e.g., wet aggregate slurry) which is propelled (e.g., by propulsion assembly 850) onto the dewatering screen 900. The dewatering screen is vibrated by a vibratory mechanism 950. As material moves across the dewatering screen, one or more spray bars or other washing elements optionally apply water to the material. Undersize material (e.g., comprising undersize aggregate material and water) optionally passes through a deck 910 into an underflume 1120. A pump optionally returns undersize material via feed conduit 1140 to the feed inlet of the hydrocyclone 1110. The underflow 1115 (which may be referred to as an underflow outlet) of the hydrocyclone 1110 optionally deposits a first subset (e.g., higher density subset) of the returned undersize material onto the deck 910. The overflow (which may be referred to as an overflow outlet) of the hydrocyclone 1110 optionally transfers a second subset (e.g., lower density subset) of the returned undersize material away from the washing apparatus 1000, e.g., via conduit 1150. In some embodiments the recirculation circuit (including the hydrocyclone) are omitted.

Ranges recited herein are intended to inclusively recite all values and sub-ranges within the range provided in addition to the maximum and minimum range values. Headings used herein are simply for convenience of the reader and are not intended to be understood as limiting or used for any other purpose.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. A sand production system, comprising:
a crusher;
a vibratory screen; and
a washing apparatus, said washing apparatus comprising a slurry agitator and a dewatering screen.

2. The sand production system of claim 1, wherein said vibratory screen and said washing apparatus are in material communication such that a first fraction of underflow passing through said vibratory screen enters said slurry agitator of said washing apparatus.

3. The sand production system of claim 2, further comprising:
a blending gate assembly, wherein said blending gate assembly is configured to direct an additional adjustable second fraction of material to said slurry agitator of said washing apparatus.

4. The sand production system of claim 3, wherein said vibratory screen and said crusher are in material communication such that an adjustable third fraction of underflow passing over one or more decks of said vibratory screen enters an inlet of said crusher.

5. The sand production system of claim 4, further comprising:
a conveyor, said conveyor disposed to recirculate at least a fraction of an output of said crusher back to an inlet of said vibratory screen.

6. The sand production system of claim 5, wherein said blending gate assembly directs an adjustable fourth fraction of material to a first stockpile.

7. The sand production system of claim 6, further comprising:
a second conveyor, wherein said conveyor is disposed to transfer at least a fraction of an output of said washing apparatus on a second stockpile.

8. The sand production system of claim 7, wherein said crusher comprises a vertical shaft impact crusher.

9. The sand production system of claim 7, wherein said vibratory screen comprises three decks of classifying media.

10. The sand production system of claim 7, wherein said vibratory screen comprises four decks of classifying media.

11. A sand production plant, comprising:
a crusher comprising a vertical shaft impact crusher;
a vibratory screen comprising at least three decks of classifying media;
a washing apparatus, said washing apparatus comprising a slurry agitator and a dewatering screen; and
at least a first conveyor disposed between said crusher and said vibratory screen.

12. The sand production plant of claim 11, wherein said vibratory screen and said washing apparatus are in material communication such that a first fraction of underflow passing through said vibratory screen enters said slurry agitator of said washing apparatus.

13. The sand production plant of claim 12, further comprising:
a blending gate assembly, wherein said blending gate assembly is configured to direct an additional adjustable second fraction of material to said slurry agitator of said washing apparatus.

14. The sand production plant of claim 13, wherein said vibratory screen and said crusher are in material communication such that an adjustable third fraction of underflow passing over one or more decks of said vibratory screen enters an inlet of said crusher.

15. The sand production plant of claim 14, further comprising:
a conveyor, said conveyor disposed to recirculate at least a fraction of an output of said crusher back to an inlet of said vibratory screen.

16. A method for producing sand, comprising:
classifying aggregate material by a vibratory screen to produce a first subset of classified material and a second subset of classified material;
directing said first subset of classified material to an agitator;
directing said second subset of classified material to a blending gate assembly;
by said blending gate assembly, blending said first subset of classified material to produce a first fraction, a second fraction, and a third fraction;
directing said first fraction to a crusher;
by said crusher, crushing said first fraction to produce a crushed first fraction;
directing said crushed first fraction back to said vibratory screen;
directing said second fraction to a first stockpile;
directing said third fraction to said agitator;
by said agitator, agitating said first subset of classified material and said third fraction to produce an agitated slurry;
by a dewatering screen, dewatering said agitated slurry to produce a dewatered agitated slurry; and
directing said dewatered agitated slurry to a second stockpile.

17. The method of claim 16, wherein said crusher comprises a vertical shaft impact crusher.

18. The method of claim 16, wherein said vibratory screen comprises four decks of classifying media.

19. The method of claim 17, wherein said vibratory screen comprises three decks of classifying media.

20. The method of claim 17, wherein said vibratory screen comprises four decks of classifying media.
